(19) United States
(12) Patent Application Publication
(10) Pub. No.: US 2002/0071539 A1
(43) Pub. Date: Jun. 13, 2002

(54) Method and apparatus for telephony-enabled instant messaging

(76) Inventors: Marc Diament, Mountain Lakes, NJ (US); Vijay Saraswat, Mountain Lakes, NJ (US)

Correspondence Address: Mr. S. H. Dworetsky, AT & T Corp., P.O. Box 4110, Middletown, NJ, 07748, US

(21) Appl. No.: 09/733,971

(22) Filed: Dec. 12, 2000

Related U.S. Application Data
(60) Provisional application No. 60/220,510, filed on Jul. 25, 2000.

(51) Int. Cl. H04M 3/42; G06F 15/16

(52) U.S. Cl. 379/202.01; 709/206

(57) ABSTRACT

A method and apparatus provide a service for permitting parties to engage in instant messaging and to allow parties so engaged to initiate a separate telephone call which may be billed. According to one method a server, referred to as a Phone Web server acts as an interface between a computer user and a telephone user. The interface is coupled to an instant messaging platform enabling the two users to exchange instant messages. One user can prompt the other to suggest the initiation of a telephone call. If the other party accepts the suggestion then the Phone Web server brokers a phone call between the two parties. In a variation of this embodiment both users could be communicating via computers and can launch the telephone initiation process.

### BACKGROUND OF THE INVENTION

The present invention is directed to a method and apparatus for controlling communication connections between two parties. Specifically, the present invention is directed to a method for enabling partiesa engaged in one form of communication to automatically initiate a telephone call between the parties.

Today people are provided with many options for conmmunicating. Beyond the traditional land line telephone connections between individuals, parties have the option of subscribing to such services as wireless telephone networks, wireless digital personal communication services (PCS), paging services or other telephone-based services. Alternatively, the exchange of text information has also allowed communications to proliferate. Users having access to computer devices such as personal computers (PCs) with access to data communication networks can exchange text messages and thereby conduct communications over those data networks. In yet another variation, data communications networks such as the Internet provide an opportunity for telephony referred to commonly as IP telephony (Internet Protocol telephony).

One popular form of text communication is instant messaging. Conventional instant messaging systems such as America Online's Instant Messenger (AIM), ICQ, Ding!, and others provide instant messaging between parties all around the world. At times, one or more of the parties engaging in instant message communications may desire to change the medium for communications to establish a telephone connection between the parties. It would be beneficial if the instant messaging system provided a simple-to-use capability for instituting such a shift of communications media.

### SUMMARY OF THE INVENTION

The present invention provides a method by which communicating parties can control whether they will communicate over a first communication medium or service or whether they will engage in automatically setting up a second communication over a second communication medium or service. In particular, parties to an instant messaging communication system are provided with the capability of initiating a telephone call between the parties. In one embodiment of the present invention, as the parties engage in exchanging instant messages, one of the parties can suggest to another party the desire to institute a telephone call. The party receiving the request can respond either positively or negatively. If the party responds negatively, the instant messaging session can continue or the communication may terminate in due course. If, however, the second party agrees to establish this second communication medium connection then the present invention provides for an automatic set up of a telephone conference call between the first and the second parties. In one embodiment of the present invention, this conference call is set up without any exchange of telephone number information between the first and the second party. As a consequence, the relative anonymity of the parties can be maintained while still establishing the telephone call.

### BRIEF DESCRIPTION OF THE DRAWINGS

FIG. 1 illustrates a known communication arrangement.

FIG. 2 illustrates a communication arrangement in accordance with an embodiment of the present invention.

FIG. 3 is a block diagram of an element of the arrangement of FIG. 2.

FIG. 4 illustrates a communication arrangement in accordance with a second embodiment of the present invention.

### DETAILED DESCRIPTION

As described above, it is known in the art to provide instant messaging arrangements which allow two parties in a data network to exchange messages. This instant messaging arrangement is a feature of AOL's AIM service and Ding!. As

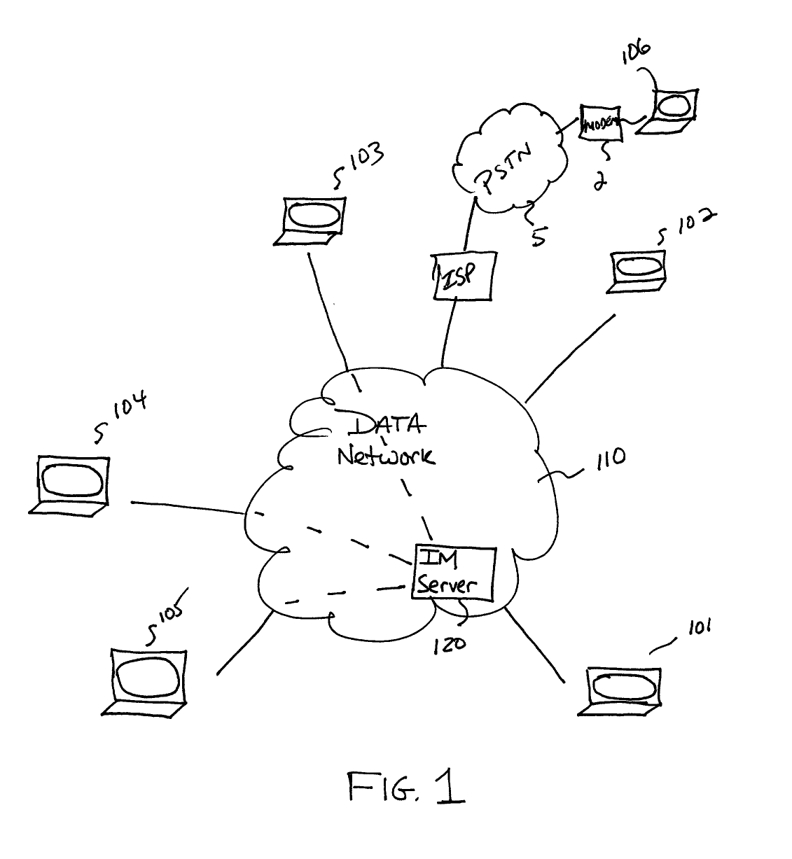

illustrated in FIG. 1, a plurality of computer devices 101 to 106 can be connected to a data network such as the Internet, 110 by various known means (such as via modem connection 2, public switched telephone network (PSTN) 5, and an Internet service provider (ISP) as one example). Alternative connections to the data network are also possible. An instant messaging (IM) server 120 is accessible by the users of the various computer devices. The instant messaging server 120 enables an instant messaging service to be provisioned to parties, such as the users of computers 101 and 103, who desire to engage in that communication service.

The present invention provides an improvement over this arrangement whereby two parties can be using two different communication media to engage in the instant messaging service. Furthermore, the arrangement permits the parties to automatically engage in an alternative communication service such as a telephone call, without having to exchange any further identification information.

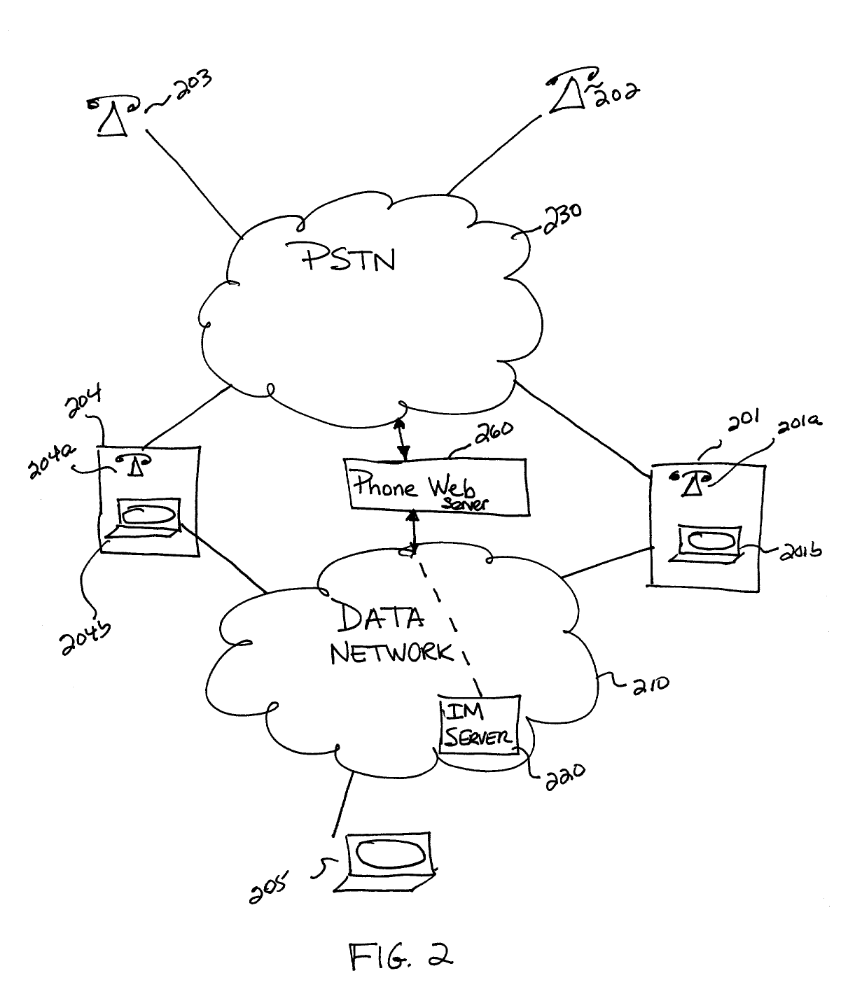

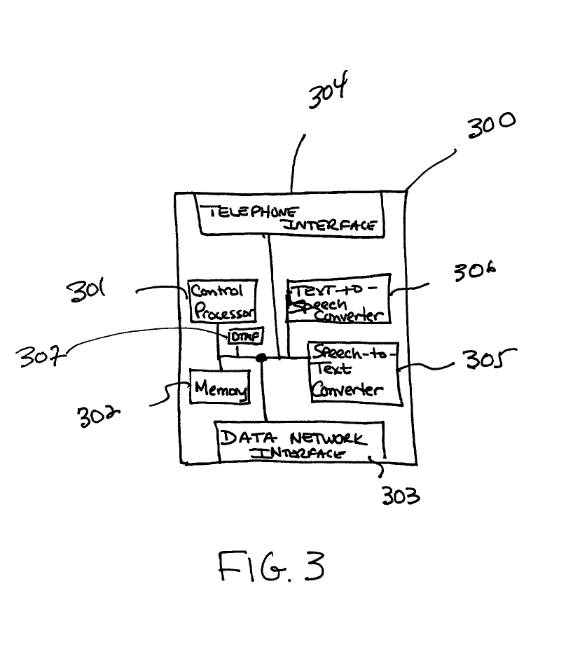

In the embodiment of FIG. 2, a data network 210 includes an IM server 220. Again, there are a plurality of communication sites 201 to 205. In this instance two of the sites, 201 and 204 include telephone and computer communication capabilities. Two of the sites, 202 and 203, are shown as providing only telephone communication capabilities. One site, 205 has computer communication capabilities. The telephones 201a, 202, 203 and 204a are all coupled to a public switched telephone network (PSTN) 230. The computer devices 201B, 204B and 205 are all coupled to the data network 210 by known means such as those described above with regard to the prior art. The system of FIG. 2 farther includes a server referred to as the Phone Web server 260. The Phone Web server serves as an interface device which allows two parties to communicate even though they may be using two different types of communication devices. In this instance, the Phone Web server allows a user of telephone 202 to engage in instant messaging with a user of computer device 205. Presuming for a moment that the instant messaging originates with telephone 202, the Phone Web server receives the telephone call and can translate either keypad entries or voice entries into commands and text messages. The Phone Web server is coupled to the data network can be coupled with the IM server 220 via that network. The Phone Web server therefore appears to the IM server as a computing device which acts as a stand in for one or more telephone devices and in this particular instance, telephone device 202. The IM server can then conduct the typical instant messaging operation with, for example, the user of computing device 205. Return text messages from the computing device and IM server are converted by the Phone Web server 260 into synthesized speech which enables the user at telephone 202 to receive one or more messages without having access to a text messaging device. The elements of the Phone Web server will be described below in connection with FIG. 3.

In another functional operation, the Phone Web server provides a capability by which two parties can leave the instant messaging service arena and automatically initiate a second communication path such as a telephone call. To better explain this embodiment of the invention, it is first presumed that the users at communication stations 201 and 204 are in communication with one another. In this instance however, the user at location 201 is engaging in instant messaging using telephone 201a coupled to Phone Web server 260 via the PSTN 230. The user 204 is engaging in the instant messaging arrangement utilizing computing device 204B coupled to data network 210. The connection to the data network can be direct or indirect as described above with regard to FIG. 1. The user at computer 204 may desire to engage in a telephone conversation with the user at 201. The user at 204 can then send a message to that effect to user 201 via IM server 220 which generates an appropriately formatted text instant message that is received by Phone Web server 260. The Phone Web server then generates a synthesized speech output to provide the contents of the text instant message to the user 201 via PSTN 230. The message may contain an instruction to the user at 201 to signify the acceptance of the offer to engage in a telephone conversation. Such acceptance could be signified by a voice acknowledgment such as “yes” or by some keypad entry which would then be detected by the Phone Web server 260. If the user at telephone 201 does accept the request to engage in a telephone conversation, then the Phone Web server can initiate a telephone conference between the parties at 201 and 204. In particular, the user at 204 may provide telephone number information to the Phone Web server when requesting the telephone call. Alternatively, the Phone Web server may have

access to user profiles which include one or more telephone numbers corresponding to the user at 204. Then, when the Phone Web server 260 detects that the users at 201 and 204 desire to engage in a telephone conversation, the phone web server can issue control signals to a telephone conference bridge to initiate outbound calls via PSTN to both 204a and 201a. The conference bridge can then bridge together the two outbound calls thereby allowing the parties at 201 and 204 to engage in a telephone conversation. The arrangement is such that only the Phone Web server needs to know the telephone numbers of the parties engaging in the telephone conversation. That information need not be exchanged between the parties themselves. This preserves the relative anonymity of the respective parties desiring to engage in the telephone call until such time as the parties themselves decide to exchange such information. As for billing, the fact that the Phone Web server launches two separate phone calls enables the billing to be divided between parties 201 and 204. In particular, each party can be charged for its own leg of the conferenced call. Alternatively, arrangements could be made whereby the requestor or the acceptor agrees to accept the charges for the entire cost of the phone call.

Additionally, the two parties could negotiate or broker the terms of the telephone call in the instant messaging session. Thus, in accordance with an embodiment of the present invention, a Phone Web server 260 acts as an interface device that enables two users to first communicate via two different media in one communication service and then permits the users to automatically initiate a second communication connection via a second communication service.

FIG. 3 provides a block diagram of elements of an embodiment of a Phone Web server. The server is the computer device which has a control processor 301 and memory 302. The memory may include both volatile and non-volatile memory. The memory may also include a database to which the control processor is coupled and which can be searched for or store various information such as user or subscriber profiles. The server also has a data network interface 303 which enables the server to be coupled to the data network as shown in FIG. 2 where that data network could be a local area network, an intra-net or wide area network such as the Internet. A telephone interface 304 enables coupling to a telephone network such as

the PSTN as shown in FIG. 2 or other private line or wireless network. The details of these two converter devices are not important to the operation of the present invention and known converters may be used to provide this functionality. A speech-to-text converter, 305 enables speech input to the device via the telephone interface 304 to be converted to text for transfer via the data network as described above. Alternatively, a text-to-speech converter 306 enables text received from the data network to be converted into speech utilizing a speech synthesizer thereby providing audio information to a user coupled to the telephone interface 304 via some telephone network. In addition, the phone web server may include a DTMF detector 307 which is responsive to keypad entries by a telephone user coupled to the telephone interface 304. It should be realized that as additional functionality and features of the Phone Web server are defined, many of those features can be implemented in software to be executed by the control processor 301. The control processor itself can comprise one or more processors capable of executing programs stored in memory. The features can be implemented by separate or integrated software modules stored in the memory 302 or in the database referred to above.

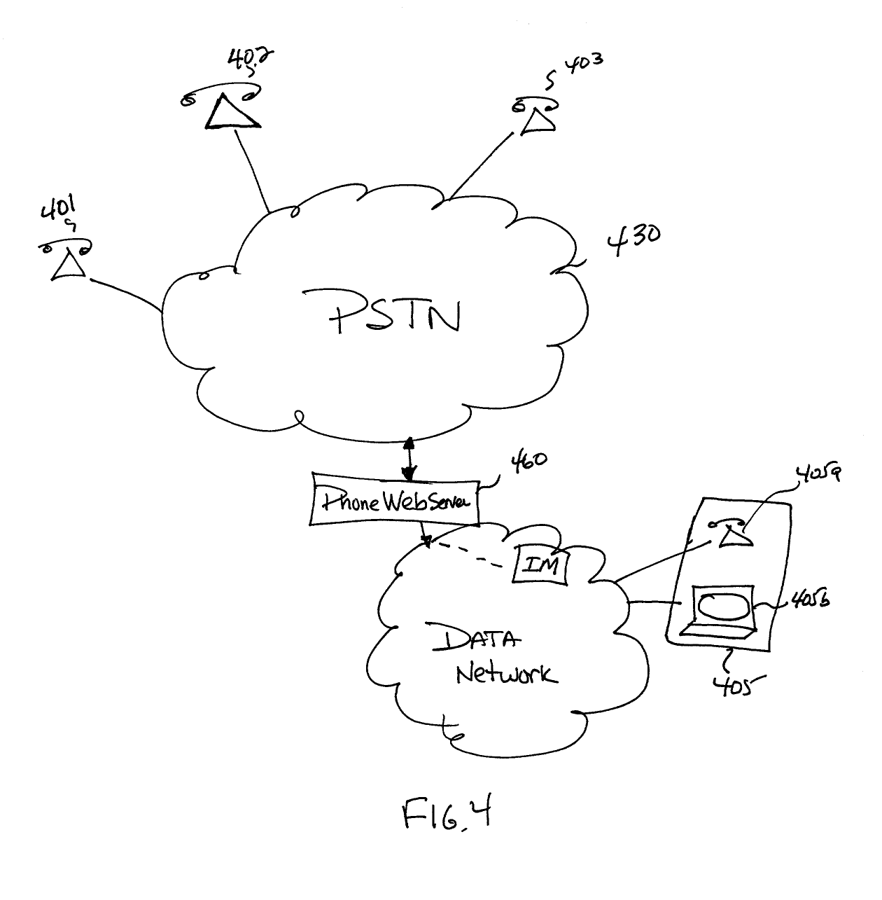

FIG. 4 illustrates another scenario in which the Phone Web server can provide access to an alternative communication service. In this instance, the user at 405 has telephone 405a and computing device 405b. The user at 405 may be engaged in instant messaging communication with each of the users at telephones 401, 402 and 403 via PSTN 430 and Phone Web server 460. In this instance, the user at 405 may desire to engage in a conference call with one or more of the users at telephones 401, 402 and 403. The user at 405 can generate an instant message to that effect which enables the users at 401 to 403 to receive a request to enter into a separate telephone conference. Then, as in FIG. 2, the Phone Web server, upon receipt of an acceptance of such a request can initiate a telephone conference via conferencing bridges (not shown), coupled to PSTN 430 to couple together some or all of the parties with whom the user 405 was engaging in instant messaging.

In yet another embodiment, described in relation to FIG. 2, the users at 204 and 201 could be engaged in data instant messaging via the data network 210 and their respective computing devices 201B and 204B. In this instance, one of the users may desire to engage in a telephone conference with the other. The user could generate an instant message which could be transported to user 204. That instant message could contain a URL that corresponds to the Phone Web server. Activation or selection of the URL by the browser of user 204 would indicate a willingness to accept user 201's invitation to engage in a telephone conference. Once the user 204 selects on the URL a connection is made to the Phone Web server 260, which transfers web page information to user 204 to initiate the telephone conference. This web page information could include prompts to provide telephone identification information which the phone web server 260 would utilize to set up the call between users 201 and 204. After phone web server gathers the appropriate information for establishing the phone call, the call between telephone devices 201a and 204a can be established in the same manner as described above.

In accordance with the present invention, two users may have two different types of communication devices engaged in a first service such as an instant messaging service thanks to the interface capabilities provided by Phone Web server 260 (460). In addition, the capabilities of the present invention permit the users to indicate to one another the desire to initiate a second form of communication between the parties utilizing a different communication technique. In the examples discussed above, this technique is a telephone call via the PSTN. In such an instance when both parties agree to engage in such alternative communications, the control device, via the Phone Web server, can initiate the communication and establish the connection between the parties as desired. The operation can be done in a manner which facilitates billing either one or both of the parties and at the same time maintains the relative anonymity of the parties. established in the same manner as described above.

In accordance with the present invention, two users may have two different types of communication devices engaged in a first service such as an instant messaging service thanks to the interface capabilities provided by Phone Web server 260 (460). In addition, the capabilities of the present invention permit the users to indicate to one another the desire to initiate a second form of communication between the parties utilizing a different communication technique. In the examples discussed above, this technique is a telephone call via the PSTN. In such an instance when both parties agree to engage in such alternative communications, the control device, via the Phone Web server, can initiate the communication and establish the connection between the parties as desired. The operation can be done in a manner which facilitates billing either one or both of the parties and at the same time maintains the relative anonymity of the parties.

What is claimed is:

1. A method for controlling communication connections between two parties, comprising:
establishing an instant messaging communication connection between a first party and a second party;
receiving a request from one of said first party and said second party to initiate a telephone call between the two parties;
forwarding the request to the other one of said first party and said second party;
receiving a positive response to said request from said other one party; and
brokering a telephone call between said first party and said second party based on said request and said response.

2. The method of claim 1 wherein said first party uses a telephone device in said instant messaging connection and said second party uses a computer in said instant messaging connection.

3. The method of claim 2, further comprising, receiving a text message from said second party;
converting said text message to speech; and
transmitting said speech to said first party.

4. The method of claim 3 further comprising,
receiving a signal based on a DTMF signal from said first party; and said brokering step includes,
initiating, in response to said reduced DTFM-based signal, a phone connection to said second party and
bridging a phone connection to said first party with said phone connection to said second party.

5. The method of claim 1 wherein said first party uses a first computer in said instant message connection and said second party uses a second computer in said instant messaging connection.

6. The method of claim 5 wherein said request from the first party comprises a URL to a server page.

7. The method of claim 6 wherein said positive response includes a request to access said server page.

8. The method of claim 7 wherein said brokering includes launching a conference call to a first telephone device associated with said first party and to a second telephone device associated with said second party.

9. A method for enabling a telephone connection between two parties comprising:
providing a first communication path between the two parties;
transporting a message from a first party to a second party requesting a telephone connection between the parties;
accepting a command from said second party to initiate a conference call between said first party and said second party;
initiating a telephone call to said first party; and
bridging said telephone call to a telephone connection to said second party.
